(19) United States
(12) Patent Application Publication
(10) Pub. No.: US 2007/0123176 A1
(43) Pub. Date: May 31, 2007

(54) Direct conversion rf front-end transceiver and its components

(76) Inventors: Seon Ho Han, Daejeon (KR); Hyun Kyu Yu, Daejeon (KR); Mun Yang Park, Daejeon (KR); Jong Dae Kim, Daejeon (KR)

Correspondence Address: LADAS & PARRY LLP, 224 SOUTH MICHIGAN AVENUE, SUITE 1600, CHICAGO, IL, 60604, US

(21) Appl. No.: 10/572,725

(22) PCT Filed: Sep. 21, 2004
(86) PCT No.: PCT/KR04/02420

§ 371 Date: Mar. 21, 2006

(30) Foreign Application Priority Data
Dec. 26, 2003 (KR) 10-2003-0097262

(51) Int. Cl. H04B 1/40; H04M 1/00

(52) U.S. Cl. 455/84; 455/550.1

(57) ABSTRACT

Provided is an RF front-end transceiver having an oscillator for outputting a resonant frequency signal whose frequency is controlled by a frequency control signal provided from a frequency synthesizer or a base band processor; a receive amplifier for amplifying and outputting a receive RF signal; a receive mixer for mixing the receive RF signal amplified and the resonant frequency signal to convert the receive RF signal into a receive base band signal; a transmit mixer for mixing a transmit base band signal and the resonant frequency signal to convert the transmit base band signal into a transmit RF signal; and a transmit amplifier for amplifying and outputting the transmit RF signal, wherein a resonant frequency of at least one of the receive amplifier, the receive mixer, the transmit mixer and the transmit amplifier is controlled by the frequency control signal.

### BACKGROUND ART

1. Field of the Invention

The present invention relates to an RF front-end transceiver and, more particularly, to a direct conversion RF front-end transceiver and its components with which a frequency band can be reconfigured by a frequency control signal that controls an oscillator.

2. Discussion of Related Art

An RF front-end transmitter for a wireless communication is composed of a transmit mixer and a transmit amplifier. The transmit mixer serves to multiply a carrier frequency with a base band signal outputted from a base band processor and convert it into a radio frequency (RF) signal. The transmit amplifier amplifies and outputs power of an output signal of the transmit mixer. With such configuration, the RF front-end transmitter converts the inputted base band signal into the RF signal and amplifies, and outputs it. A RF front-end receiver for a wireless communication is composed of a receive amplifier and a receive mixer. The receive amplifier amplifies and outputs a small signal inputted through an antenna. The receive mixer converts the RF signal outputted from the receive amplifier into the base band signal and outputs the converted base band signal. With such configuration, the RF front-end receiver amplifies the input RF signal and converts the amplified input RF signal into the base band signal and outputs it.

In designing the RF front-end transceiver, impedance should be matched to transmit maximum power. Generally, in implementing a wireless communication system, 50 ohm is used as a matching point, considering power transmission of electromagnetic wave energy and distortion of a signal waveform. That is, input impedance and output impedance should be matched to 50 ohm. The impedance mentioned herein is a concept including resistance and reactance. Therefore, 50 ohm impedance matching means that the reactance is 0. That is, to achieve the 50 ohm impedance matching, resonance caused by an inductor and a capacitor is used. Therefore, a specific RF front-end transceiver transmits the maximum power over a specific frequency band where the resonance is generated by the inductor and the capacitor, while it does not transmit the maximum power over the frequency band other than the above one. In other words, the maximum power can be transmitted around the resonance frequency of the receive amplifier, the receive mixer, the transmit amplifier and the transmit mixer, while it cannot transmit over the frequency band other than the above one. Due to this feature, there are problems that the specific RF front-end transceiver can be used only for the specific RF frequency band, and that a number of RF front-end transceivers are required to process a number of RF frequency band signals. As such, when a number of RF front-end transceivers are employed, there are problems that a hardware design becomes complicated and the cost is high.

### SUMMARY OF THE INVENTION

The present invention is directed to providing a direct conversion RF front-end transceiver and its components with which a signal processing frequency band can be reconfigured by a frequency control signal.

To address the foregoing problems, a first aspect of the present invention provides an RF front-end transceiver comprising: an oscillator for outputting a resonant frequency signal whose frequency is controlled by a frequency control signal; a receive amplifier for amplifying and outputting a receive RF signal; a receive mixer for mixing the receive RF signal amplified and the resonant frequency signal to convert the receive RF signal into a receive base band signal; a transmit mixer for mixing a transmit base band signal and the resonant frequency signal to convert the transmit base band signal into a transmit RF signal; and a transmit amplifier for amplifying and outputting the transmit RF signal, wherein a resonant frequency of at least one of the receive amplifier, the receive mixer, the transmit mixer and the transmit amplifier is controlled by the frequency control signal.

A second aspect of the present invention provides an RF front-end receiver comprising: an oscillator for outputting a resonant frequency signal whose frequency is controlled by a frequency control signal; a receive amplifier for amplifying and outputting a receive RF signal; and a receive mixer for mixing the receive RF signal amplified and the resonant frequency signal to convert the receive RF signal into a receive base band signal, wherein a resonant frequency of a least one of the receive amplifier and the receive mixer is controlled by the frequency control signal.

A third aspect of the present invention provides an RF front-end transmitter comprising: an oscillator for outputting a resonant frequency signal whose frequency is controlled by a frequency control signal; a transmit mixer for mixing a transmit base band signal and the resonant frequency signal to convert the transmit base band signal into a transmit RF signal; and a transmit amplifier for amplifying and outputting the transmit RF signal, wherein a resonant frequency of at least one of the transmit mixer and the transmit amplifier is controlled by the frequency control signal.

A fourth aspect of the present invention provides an amplifier comprising: an amplification unit for amplifying a signal inputted to an input unit and outputting the amplified signal to an output unit; and an input resonant unit connected to the input unit, and for changing a resonant frequency in accordance with a frequency control signal, wherein the frequency control signal is used to control a frequency of a resonant frequency signal outputted from an oscillator.

### BRIEF DESCRIPTION OF THE DRAWINGS

FIG. 1 is a structure diagram of a direct conversion RF front-end transceiver according to a first embodiment of the present invention;

FIG. 2 is a structure diagram of a direct conversion RF front-end receiver according to a first embodiment of the present invention;

FIG. 3 is a structure diagram of a direct conversion RF front-end transmitter according to a first embodiment of the present invention;

FIGS. 4 and 5 are diagrams showing examples of amplifiers that can be employed in the direct conversion RF front-end transceiver, transmitter and receiver of FIGS. 1 to 3;

FIGS. 6 through 9 are diagrams for illustrating a resonant circuit (an LC tank) controlled by a digital control signal and an analog control signal;

FIG. 10 is a structure diagram of a direct conversion RF front-end transceiver according to a second embodiment of the present invention;

FIG. 11 is a structure diagram of a direct conversion RF front-end receiver according to a second embodiment of the present invention;

FIG. 12 is a structure diagram of a direct conversion RF front-end transmitter according to a second embodiment of the present invention;

FIG. 13 is a structure diagram of a direct conversion RF front-end transceiver according to a third embodiment of the present invention;

FIG. 14 is a structure diagram of a direct conversion RF front-end receiver according to a third embodiment of the present invention;

FIG. 15 is a structure diagram of a direct conversion RF front-end transmitter according to a third embodiment of the present invention;

FIG. 16 is circuit diagram showing an example of a switched capacitor LC tuned VCO that is frequency-variable by a digital control signal and an analog control signal;

FIG. 17 is a diagram showing an amplifier that can be used in an RF front-end transceiver according to a third embodiment of the present invention; and

FIG. 18 is a diagram showing a mixer according to a second embodiment of the present invention.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art.

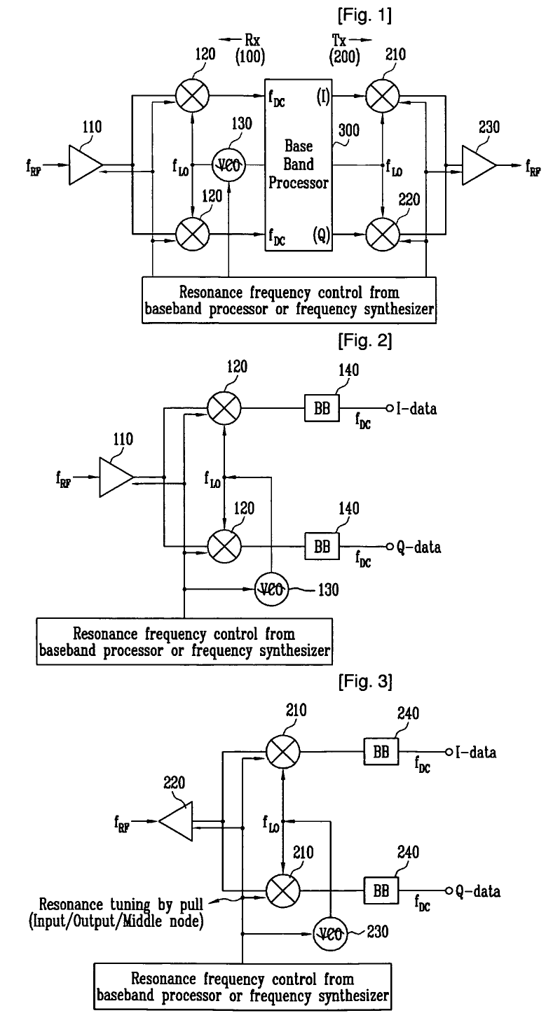

FIGS. 1 through 3 are diagrams for illustrating a direct conversion RF front-end transceiver, receiver and transmitter according to a first embodiment of the present invention.

FIG. 1 is a structure diagram of a direct conversion RF front-end transceiver according to a first embodiment of the present invention. In FIG. 1, the direct conversion RF front-end transceiver is composed of an RF front-end receiver 100 and an RF front-end transmitter 200. The RF front-end receiver 100 is composed of a receive amplifier 110, a receive mixer 120 and a voltage controlled oscillator (VCO) 130. The RF front-end transmitter 200 is composed of a transmit mixer 210 and a transmit amplifier 220.

The receive amplifier 110 amplifies and outputs a receive RF signal inputted through an antenna (not shown). The receive mixer 120 mixes the receive RF signal outputted from the receive amplifier 110 and the output resonant frequency f_{LO} outputted from the VCO 130 to convert the receive RF signal into a receive base band signal. In the receive amplifier 110 and the receive mixer 120, a resonant frequency is controlled by a resonant frequency control signal. The VCO 130 outputs the output resonant frequency signal f_{LO} whose frequency is controlled by the resonant frequency control signal. The output resonant frequency f_{LO} corresponds to a carrier frequency. The resonant frequency control signal can be provided from the base band processor 300 or a frequency synthesizer. The transmit mixer 210 mixes a base band signal outputted from the base band processor 330 and the resonant frequency f_{LO} outputted from the VCO 130 to convert the base band signal into an RF signal. The transmit amplifier 220 amplifier and outputs the output signal power of the transmit mixer 210. The resonant frequency of the transmit mixer 210 and the transmit amplifier 220 is controlled by the resonant frequency control signal.

With this configuration, the RF front-end transceiver amplifies the inputted RF signal and converts it into the base band signal to output to the base band processor 300, and converts the base band signal outputted from the base band processor 300 into the RF signal and amplifies and outputs the converted RF signal. Further, the same resonant frequency control signal controls the resonant frequency f_{LO} outputted from the VCO 130 as well as the resonant frequency of the receive amplifier 110, the receive mixer 120, the transmit mixer 210 and the transmit amplifier 220, so that the maximum power can be transmitted even when the signal processing frequency band of the RF front-end transceiver is changed. This direct conversion RF front-end transceiver uses a fact that the frequency of the RF signal f_{RF} is equal to the output resonance frequency f_{LO} of the VCO where each of the receive amplifier 110, the receive mixer 120, the transmit mixer 210 and the transmit amplifier 220 includes a replica LC resonant circuit similar to an LC resonant circuit. However, the replica LC resonant circuit has a parasitic inductor or a parasitic capacitor, etc., so that it is not the exactly same one as the LC resonant circuit used in the VCO 130.

FIG. 2 is a structure diagram of the direct conversion RF front-end receiver according to a first embodiment of the present invention. In FIG. 2, a direct conversion RF front-end receiver is composed of a receive amplifier 110, a receive mixer 120, a voltage controlled oscillator (VCO) 130 and an Base band (BB) 140. The BB 140 is composed of a VGA (Variable Gain Amplifier), a Filter and an analog to digital converter (ADC).

The receive amplifier 110 amplifies and outputs a small signal inputted through an antenna (not shown). The receive mixer 120 mixes the receive RF signal outputted from the receive amplifier 110 and the resonant frequency f_{LO} outputted from the VCO 130 to convert the receive RF signal into a receive base band signal. In the receive amplifier 110 and the receive mixer 120, a resonant frequency is controlled by the resonant frequency control signal. The VCO 130 outputs the output resonant frequency f_{LO} where the resonant frequency is controlled by the resonant frequency control signal. The resonant frequency control signal can be provided from the base band processor (not shown) or a frequency synthesizer (not shown). The BB 140 amplifies and filters the analog base band signal outputted from the receive mixer 120, and converts the analog base band signal into a digital signal.

With this configuration, the RF front-end receiver amplifies the inputted RF signal and converts it into a digital base band signal to output to the base band processor 300. Further, the resonant frequency f_{LO} outputted from the VCO 130 as well as the resonant frequency of the receive amplifier 110 and the receive mixer 120 are controlled by the same resonant frequency control signal, so that the maximum power can be transmitted even when the signal processing frequency band of the RF front-end receiver is changed. This direct conversion RF front-end receiver uses a fact that the RF signal frequency f_{RF} is equal to the output frequency f_{LO} of the VCO,where each of the receive amplifier 110 and the receive mixer 120 includes a replica LC resonant circuit similar to an LC resonant circuit. However, the replica LC resonant circuit has a parasitic inductor or a parasitic capacitor, etc., so that it is not the exactly same one as the LC resonant circuit used in the VCO 130.

FIG. 3 is a structure diagram of a direct conversion RF front-end transmitter according to a first embodiment of the present invention. In FIG. 3, a direct conversion RF front-end transmitter is composed of a transmit mixer 210, a transmit amplifier 220, a voltage controlled oscillator (VCO) 230 and a Base band (BB) 240. The BB 240 is composed of a VGA (Variable Gain Amplifier), a Filter and an digital to analog converter (DAC).

The BB 240 converts a digital base band signal into an analog base band signal, and amplifies and filters the digital base band signal. The transmit mixer 210 mixes a base band signal outputted from the base band processor 330 and the resonant frequency f_{LO} outputted from the VCO 230 to convert the base band signal into an RF signal. The transmit amplifier 220 amplifies and outputs the output signal power of the transmit mixer 210. The resonant frequency of the transmit mixer 210 and the transmit amplifier 220 are controlled by the resonant frequency control signal. The VCO 230 outputs the resonant frequency signal f_{LO} whose frequency is controlled by the resonant frequency control signal. The resonant frequency control signal can be provided from the base band processor (not shown) or a frequency synthesizer (not shown).

With this configuration, the RF front-end transmitter converts a digital base band signal into an RF signal and amplifies and outputs it. Further, the resonant frequency f_{LO} outputted from the VCO 130 as well as the resonant frequency of the transmit mixer 210 and the transmit amplifier 220 are controlled by the same resonant frequency control signal, so that the maximum power can be transmitted even when the signal processing frequency band of the RF front-end transmitter is changed. This direct conversion RF front-end transmitter uses a fact that the RF signal frequency f_{RF} is equal to the output frequency f_{LO} of the VCO, where each of the transmit mixer 210 and the transmit amplifier 220 includes a replica LC resonant circuit similar to an LC resonant circuit. However, the replica LC resonant circuit has a parasitic inductor or a parasitic capacitor, etc., so that it is not the exactly same one as the LC resonant circuit used in the VCO 230.

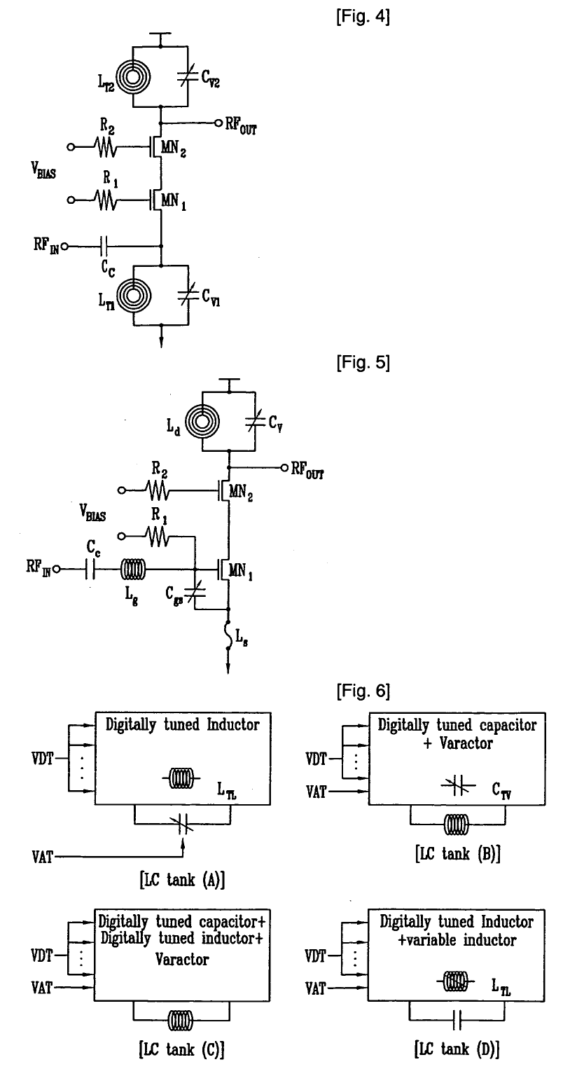

FIGS. 4 and 5 are diagrams for illustrating an amplifier that can be employed in the direct conversion RF front-end transceiver, transmitter and receiver of FIGS. 1 through 3.

The amplifier shown in FIG. 4 is a common gate amplifier in which the resonant frequency of an input and an output is variable. This amplifier is composed of an input capacitor C_{C}, first and second NMOS transistors MN₁ and MN₂, first and second resistors R₁ and R₂, an input resonant circuit L_{T1} and C_{V1} and an output resonant circuit L_{T2} and C_{V2}. Both ends of the input capacitor C_{C} are connected to an input RF signal RF_{IN} and a source of the first NMOS transistor MN₁, respectively, and serves to transmit only an alternating current signal of the input RF signal RF_{IN} to the source of the first NMOS transistor MN₁. The input resonant circuit L_{T1} and C_{V1} includes a variable capacitor C_{V1} and an inductor L_{T1} connected in parallel with the variable capacitor C_{V1}, where both ends of the input resonant circuit L_{T1} and C_{V1} are connected to the source of the first NMOS transistor MN₁ and the ground voltage. The capacitance of the variable capacitor C_{V1} is changed according to a frequency control signal, so that an input resonant frequency, that is, the resonant frequency of the input resonant circuit L_{T1} and C_{V1} is changed according to the frequency control signal. Gates of the first and second NMOS transistors MN₁ and MN₂ are connected to a bias voltage V_{BIAS} through a first resistor and a second resistor. Each of the first and second NMOS transistors MN₁ and MN₂ amplifies the source signal and transmit it to a drain. A net resistance of 50 ohm for input matching can be obtained using gm (transconductance) of the first NMOS transistor MN₁. The output resonant circuit L_{T2} and C_{V2} includes a variable capacitor C_{V2} and an inductor L_{T2} connected in parallel with the variable capacitor C_{V2}, where both ends of an output resonant circuit L_{T2} and C_{V2} are connected to the power supply voltage and the drain of the second NMOS transistor MN₂, respectively. The capacitance of the variable capacitor C_{V2} is changed according to the frequency control signal, so that the resonant frequency of the output resonant circuit L_{T2} and C_{V2} (an output resonant frequency) is changed according to the frequency control signal. With this configuration, the amplifier amplifies and outputs the input RF signal RF_{IN}, where the input resonant frequency and the output resonant frequency are controlled by the frequency control signal.

The amplifier shown in FIG. 5 is a cascode amplifier where the resonant frequency of the input and output is variable. This amplifier is composed of an input capacitor C_{C}, a gate inductor Lg, a gate-source capacitor Cgs, a source inductor Ls, first and second NMOS transistors MN₁ and MN₂, first and second resistors R₁ and R₂, and an output resonant circuit L_{d} and Cᵥ. The RF input signal RF_{IN} is inputted to a gate of the first NMOS transistor MN₁ via the input capacitor C_{C} and the gate inductor Lg. An input resonant circuit is composed of the gate inductor Lg, the gate-source capacitor Cgs and the source inductor Ls connected in series. The capacitance of the gate-source capacitor Cgs is changed according to the frequency control signal, so that a resonant frequency of the input resonant circuit (an input resonant frequency) is changed according to the frequency control signal. The gate of the first NMOS transistor MN₁ is connected to the bias voltage V_{BIAS} via the first resistance R₁. The first NMOS transistor MN₁ amplifies the gate signal and outputs it to the drain. The gate of the second NMOS transistor MN₂ is connected to the bias voltage V_{BIAS} via the second resistor R₂. The second NMOS transistor MN₂ amplifies the source signal and outputs it to the drain. The output resonant circuit L_{d} and C_{V} includes a variable capacitor C_{V} and an inductor L_{d} connected in parallel with the variable capacitor C_{V}, where both ends of the output resonant circuit L_{d} and C_{V} are connected to the drain of the second NMOS transistor MN₂ and the power supply voltage, respectively. The capacitance of the variable capacitor C_{V} is changed according to the frequency control signal, so that the resonant frequency of the output resonant circuit L_{d} and C_{V} (the output resonant frequency) is changed according to the frequency control signal. With this configuration, the amplifier amplifies and outputs the input RF signal RF_{IN}, where the input resonant frequency and the output resonant frequency are controlled by the frequency control signal.

Using the direct conversion RF front-end transceiver according to the first embodiment of the present invention, a system that can change the resonant frequency can be implemented, but there occurs a new serious problem in that the resonant frequency is changed using the variable capacitor. This will significantly degrade the signal linearity due to the nonlinear characteristic. This capacitive non-linearity is in proportion to the gain of the variable capacitor indicating a change ratio of the input controlled voltage change to the output capacitance for the used variable capacitor. Therefore, in order to obtain the desired system performance without signal distortion, the gain of the variable capacitor should be very small. Thus, in the present invention, the resonant circuit is controlled using a digital control signal and an analog control signal, to reduce the capacitive non-linearity, so that a wide-band of variable frequency band can be obtained, and also, the low frequency gain of the resonant circuit (the low capacitive non-linearity) can be obtained.

FIGS. 6 through 8 are diagrams for illustrating a resonant circuit (an LC tank) controlled by a digital control signal and an analog control signal.

FIG. 6 illustrates a method of implementing an LC tank circuit with a digital control signal VDT and an analog control signal VAT. The LC tank (A) controls an inductor with the digital control signal, so that the inductance is discretely tuned, and a variable capacitor is tuned with an analog control signal. There is a drawback that the planar inductor should be integrated into this LC tank using a silicon process, and the fine-tuning is more difficult relative to tuning the capacitor. Further, using an inductor with the switch gives a bad impact on Q of the resonant circuit. However, with regard to the overall current consumption, it is advantageous for the large frequency tuning. An LC tank (B) uses a typical switched capacitor. This LC tank uses a fixed inductor, a variable capacitor and a switched capacitor. An LC tank (C) adds a digitally tuned inductor to the circuit of the LC tank (B). This LC tank can achieve a large frequency change by tuning the inductor, so that the current consumption suitable to the variable frequency range can be obtained. Therefore, this LC tank can be used for a multi-band system where the large frequency tuning is required. For example, when operated in a low frequency ranges of the entire variable frequency range, the inductor is tuned, so that the current consumption can be reduced relative to tuning only with the reduced capacitor, and in the given frequency band, the tuning can be finely performed with the switched capacitor and the variable capacitor. An LC tank (D) shows a case where a fixed capacitor and an inductor whose inductance is changed by the digital control and the analog control are used.

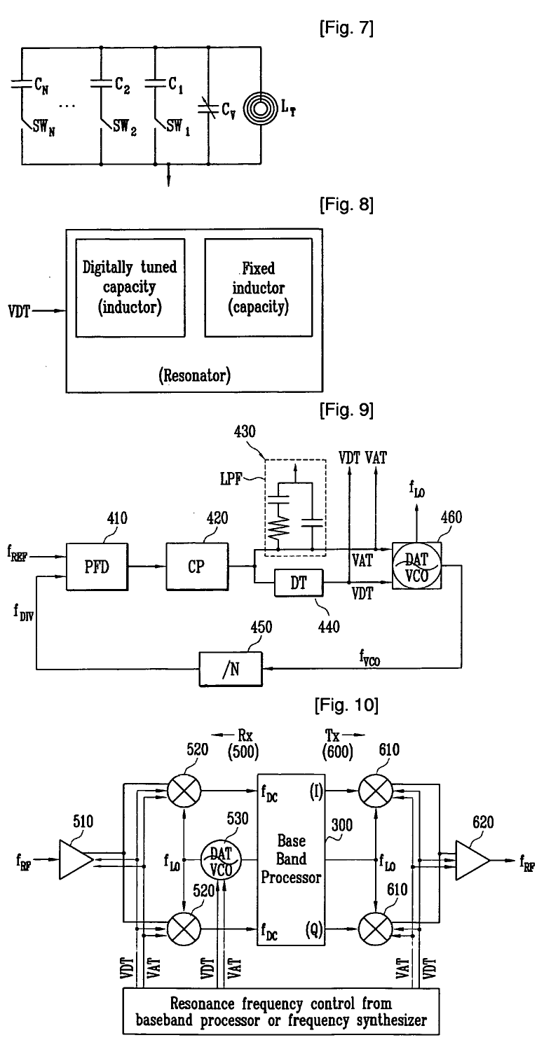

FIG. 7 is a diagram showing a resonant circuit where a variable capacitor Cv, switched capacitors C₁, SW₁˜C_{N}, SW_{N}, and an inductor L_{T} are connected in parallel. The capacitance of the variable capacitor Cv is controlled by the analog control signal. The switches SW₁˜SW_{N} are controlled by the digital control signal. This resonant circuit corresponds to the LC tank (B) of FIG. 6.

FIG. 8 is a resonant circuit controlled only by the digital control signal. This resonant circuit cannot be used in the VCO, while can be used in the receive amplifier, the receive mixer, the transmit mixer and the transmit amplifier. These are not required to exactly match the resonant frequency with the VCO, so that the resonant frequency may be controlled only by the digital control signal as illustrated in FIG. 8. When such resonant circuit is used, the minimum unit of the resonant frequency that is discretely changed by the digital control should be small in order not to have a large frequency difference with the VCO.

The existing resonant circuit used for the direct conversion RF front-end transceiver according to the first embodiment of the present invention can be replaced with the resonant circuit shown in FIGS. 6 through 8. That is, the resonant circuit shown in FIGS. 6 and 7 can be used in the VCO, the receive amplifier, the receive mixer, the transmit mixer and the transmit amplifier, and the resonant circuit shown in FIG. 8 can be used in the receive amplifier, the receive mixer, the transmit mixer and the transmit amplifier. With this, the linearity degradation due to the variable capacitor, arisen as a new issue in the direct conversion RF front-end transceiver according to the first embodiment of the present invention, can be blocked.

FIG. 9 shows a frequency synthesizer (410 to 450) and a digital analog tuning VCO (DAT-VCO) 460 that can generate the digital control signal and the analog control signal available in the resonant circuit shown in FIGS. 6 through 8.

In FIG. 9, the frequency synthesizer is composed of a phase frequency detector (hereinafter, referred to as a “PFD”) 410, a current pump (hereinafter, referred to as a “CP”) 420, a low pass filter (hereinafter, referred to as a “LPF”) 430, a digital tuner (hereinafter, referred to as a “DT”) 440 and an N divider 450. The PFD 410 compares the frequency and phase of a reference frequency f_{REF} with that of an output frequency f_{DIV} of the N divider 450 and outputs their differences. The CP 420 flows the charge that corresponds to the output of the PFD 410 into the LPF 430 of the next stage. The LPF 430 serves as a loop filter of the overall frequency synthesizer and provides the DAT-VCO 460 of the next stage with the analog control signal VAT. The DT 440 measures the analog control signal VAT periodically, and accordingly, changes the digital control signal value inputted to the DAT-VCO. When the value of the analog control signal VAT is above a predetermined upper limit at the time of a periodic measurement, the DT 440 changes the value of the digital control signal to discretely increase the frequency of the DAT-VCO, while the value of the analog control signal VAT is below a predetermined lower limit, the DT 440 changes the value of the digital control signal to discretely reduce the frequency of the DAT-VCO. When the value of the analog control signal VAT value is between the upper limit and the lower limit, the value of the digital control signal outputted from the DT 440 remains unchanged. The N divider 450 divides and outputs the DAT-VCO output frequency with a frequency ratio N. The DAT-VCO 460 controls the output frequency f_{LO} using the analog control signal VAT and the digital control signal VDT. With this configuration, the frequency synthesizer (410 to 450) outputs the analog control signal VAT and the digital control signal VDT, and the DAT-VCO 460 outputs the output frequency f_{LO} controlled by the analog control signal VAT and the digital control signal VDT.

FIGS. 10 through 12 are diagrams showing a direct conversion RF front-end transceiver according to a second embodiment of the present invention.

FIG. 10 is a structure diagram showing a direct conversion RF front-end transceiver according to a second embodiment of the present invention. The transceiver shown in FIG. 10 is similar to that shown in FIG. 1, but is different in that a receive amplifier 510, a receive mixer 520, a DAT-VCO 530, a transmit mixer 610 and a transmit amplifier 620 are controlled by the digital control signal VDT and the analog control signal VAT.

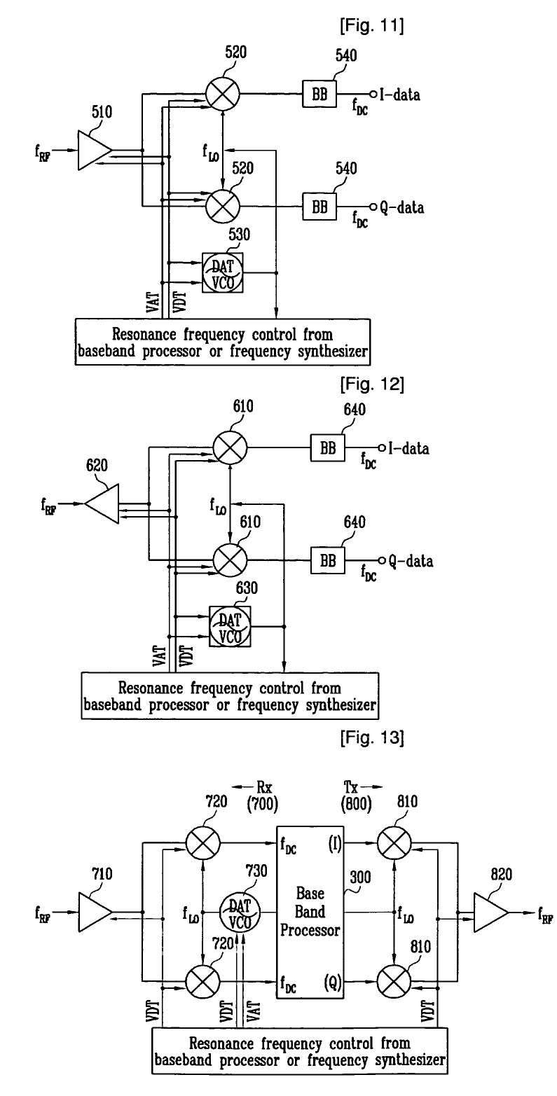

FIG. 11 is a structure diagram showing a direct conversion RF front-end receiver according to a second embodiment of the present invention. The receiver shown in FIG. 11 is similar to that shown in FIG. 2, but is different in that a receive amplifier 510, a receive mixer 520, and a DAT-VCO 530 are controlled by the digital control signal VDT and the analog control signal VAT.

FIG. 12 is a structure diagram showing a direct conversion RF front-end transmitter according to the second embodiment of the present invention. The transmitter shown in FIG. 12 is similar to that shown in FIG. 3, but is different in that a transmit mixer 610, a transmit amplifier 620, and a DAT-VCO 630 are controlled by the digital control signal VDT and the analog control signal VAT.

FIGS. 13 through 15 are diagrams showing a direct conversion RF front-end transceiver according to a third embodiment of the present invention.

FIG. 13 is a structure diagram showing a direct conversion RF front-end transceiver according to a third embodiment of the present invention. The transceiver shown in FIG. 13 is similar to that shown in FIG. 1, but is different in that a DAT-VCO 730 is controlled by the digital control signal VDT and the analog control signal VAT, and a receive amplifier 710, a receive mixer 720, a transmit mixer 810 and a transmit amplifier 820 are controlled by the digital control signal VDT.

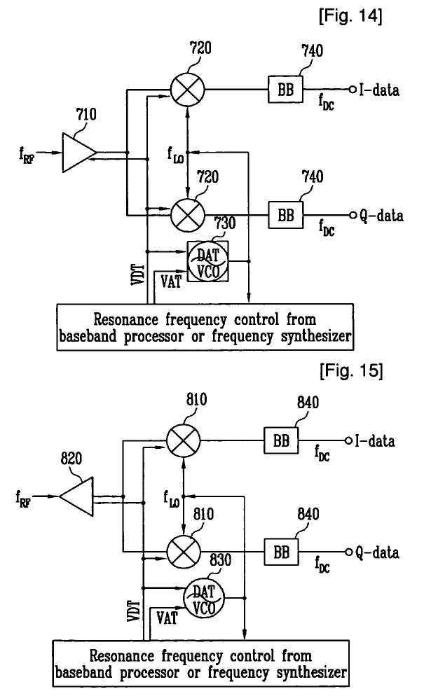

FIG. 14 is a structure diagram showing a direct conversion RF front-end receiver according to the third embodiment of the present invention. The receiver shown in FIG. 14 is similar to that shown in FIG. 2, but is different in that a DAT-VCO 730 is controlled by the digital control signal VDT and the analog control signal VAT, and a receive amplifier 710 and a receive mixer 720 are controlled by the digital control signal VDT.

FIG. 15 is a structure diagram showing a direct conversion RF front-end transmitter according to a third embodiment of the present invention. The transmitter shown in FIG. 15 is similar to that shown in FIG. 3, but is different in that a DAT-VCO 830 is controlled by the digital control signal VDT and the analog control signal VAT, and a transmit mixer 810 and a transmit amplifier 820 are controlled by the digital control signal VDT.

The direct conversion RF front-end transceiver according to the second and third embodiment of the present invention shown in FIGS. 10 through 15 acts to blocking the linearity degradation due to the inductor and the capacitor having a nonlinear characteristic in the resonant circuit of the direct conversion RF front-end transceiver according to the first embodiment of the present invention shown in FIGS. 3 through 5. Therefore, the resonant circuit used in FIGS. 10 through 15, allows the frequency to be changed continuously or discontinuously using a digital control signal and an analog control signal, so that the variable capacitor gain is reduced while the variable frequency range is widened. Further, this control signal is controlled using the frequency synthesizer shown in FIG. 9.

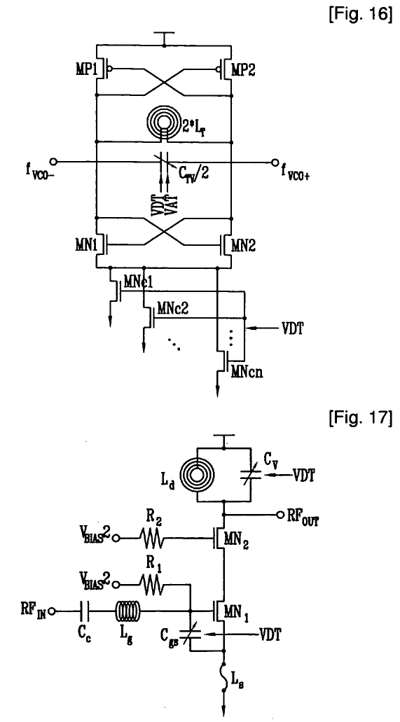

FIG. 16 is a circuit diagram showing an example of a switched capacitor LC tuned VCO where a frequency is changed by the digital control signal and the analog control signal. In FIG. 16, the resonant circuit of the VCO is composed of an inductor L_{T} and a variable capacitor C_{TV}. The variable capacitor C_{TV} is controlled by the analog control signal VAT and the digital control signal VDT. First and second NMOS transistors MN1 and MN2 and first and second PMOS transistors MP1 and MP2 have -Gm that compensates for the loss of the resonant circuit. The bias current sources MNc1 through MNcn are the bias current source for the VCO. The bias current sources MNc1 through MNcn in the drawings are set to be under the control of the VDT. When the variable frequency band of the VCO is significantly wide, the required current is variable to make the signal amplitude of the VCO large in outputting at low frequency, so that a phase noise can remain constant to some degree in the overall variable frequency band. However, when the variable frequency range of the VCO is narrow, the control for the bias current source is not required.

FIG. 17 is a diagram showing an amplifier that can be used in an RF front-end transceiver according to a third embodiment of the present invention. FIG. 17 is a cascode amplifier where input and output resonant frequencies are variable. This amplifier is composed of an input capacitor C_{C}, a gate inductor Lg, a gate-source capacitor Cgs, a source inductor Ls, first and second NMOS transistors MN₁ and MN₂, first and second resistors R₁ and R₂ and an output resonant circuit L_{d} and Cᵥ. An RF input signal RF_{IN} is inputted to the gate of the first NMOS transistor MN₁ via the input capacitor C_{C} and the gate inductor Lg. The gate inductor Lg, the gate-source capacitor Cgs and the source inductor Ls, connected in series, constitute the input resonant circuit. The capacitance of the gate-source capacitor Cgs is changed according to the digital control signal VDT. The gate of the first NMOS transistor MN₁ is connected to the first bias voltage V_{BIAS1} via the first resistor R₁. The first NMOS transistor MN₁ amplifies a gate signal and outputs it to the drain. The gate of the second NMOS transistor MN₂ is connected to the second bias voltage V_{BIAS2} via the second resistor R₂. The second NMOS transistor MN₂ amplifies the source signal and output it to the drain. The output resonant circuit L_{d} and C_{V} includes an inductor L_{d} in parallel with a variable capacitor C_{V}, where both ends of the output resonant circuit L_{d} and C_{V} are connected to the power supply voltage and the drain of the second NMOS transistor MN₂, respectively. The capacitance of the variable capacitor C_{V} is changed according to the digital control signal VDT. With this configuration, the amplifier amplifies and outputs the input RF signal RF_{IN}, and the input resonant frequency and the output resonant frequency are controlled by the digital control signal VDT.

Input impedance Zin of this amplifier is expressed in Equation. 1.

$$Zin = ( ω {L}_{g} - \frac{1}{ω {C}_{c}} - \frac{1}{ω {C}_{g s}} + ω {L}_{s} ) \cdot j + \frac{{g}_{m} {L}_{s}}{{C}_{g s}} \qquad < Equation 1 >$$

It can be found that when the gate-source capacitor Cgs is increased in Equation. 1, the net resistance of the input impedance is reduced. Therefore, when the net resistance (impedance) is increased by the digital control signal VDT, if the gm value is also increased, the net resistance can remain constant. The gm value is increased when the first bias voltage V_{BIAS1} is increased, so that when the gate-source capacitor Cgs is increased, if the first bias voltage V_{BIAS1} is designed to increase, the net resistance can remain constant. FIG. 17 also shows an example of the circuit that supplies the first bias voltage V_{BIAS1}. This circuit is composed of an inverter, n switches (sw1 through swn), n bias NMOS transistors (MN_{B1} through MN_{Bn}), a load resistor R_{LOAD}, an output resistor R_{B} and a capacitor C_{B}. When the digital control signal VDT is increased, the output of the inverter is reduced, so that the number of short switches (sw1 through swn) is also reduced. The voltage drop of the load resistor is then reduced, resulting in increasing the first bias voltage V_{BIAS1} outputted. With this configuration, when the digital control signal VDT is increased, the net resistance can remain constant by increasing the gate-source capacitor Cgs as well as the gm.

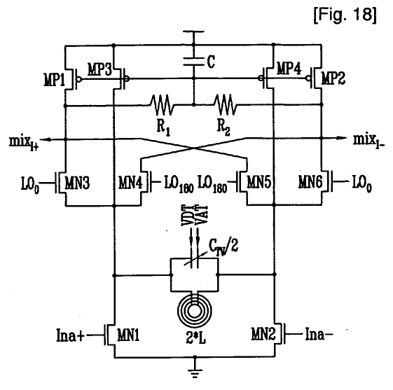

FIG. 18 shows a mixer according to a second embodiment of the present invention. Referring to FIG. 18, the mixer is composed of six NMOS transistors MN1˜MN6, four PMOS transistors MP1˜MP4, two resistors R1 and R2, a capacitor C, an inductor L and a variable capacitor C_{TV}/2. The mixer multiplies and outputs the signals Ina+ and Ina− inputted to the gate of the first and the second NMOS transistors MN1 and MN2 with the output signals of the frequency oscillator inputted to the gates of the third to sixth NMOS transistor MN3˜MN6.

Although the present invention has been specifically described with reference to the preferred embodiments, it should be noted that these embodiments are not restrictive but just illustrative. Further, those skilled in the art will appreciate that a variety of modification can be made without departing from the scope of the present invention.

According to the present invention, the direct conversion RF front-end transceiver and its components can change the resonant frequency over several frequency bands inputted from an antenna. Therefore, it has an advantage that a multi-band or wideband of signal frequency can be processed with one system hardware.

Further, the direct conversion RF front-end transceiver and its components according to the present invention can change the resonant frequency and determine the resonant frequency through programming. Therefore, it has an advantage that the resonant frequency can be determined irrespective of the process change and a platform of RF blocks or reconfigurable RF blocks can be configured.

Further, the direct conversion RF front-end transceiver and its components according to the present invention can be designed with a significantly reduced area, so that it is very competitive with respect to the costs.

1. An RF front-end transceiver comprising:
an oscillator for outputting a resonant frequency signal whose frequency is controlled by a frequency control signal;
a receive amplifier for amplifying and outputting a receive RF signal;
a receive mixer for mixing the receive RF signal amplified and the resonant frequency signal to convert the receive RF signal into a receive base band signal;
a transmit mixer for mixing a transmit base band signal and the resonant frequency signal to convert the transmit base band signal into a transmit RF signal; and
a transmit amplifier for amplifying and outputting the transmit RF signal, wherein a resonant frequency of at least one of the receive amplifier, the receive mixer, the transmit mixer and the transmit amplifier is controlled by the frequency control signal.

2. The RF front-end transceiver according to claim 1, wherein the frequency control signal is provided from a frequency synthesizer or a base band processor.

3. An RF front-end receiver comprising:
an oscillator for outputting a resonant frequency signal whose frequency is controlled by a frequency control signal;
a receive amplifier for amplifying and outputting a receive RF signal; and
a receive mixer for mixing the receive RF signal amplified and the resonant frequency signal to convert the receive RF signal into a receive base band signal, wherein a resonant frequency of at least one of the receive amplifier and the receive mixer is controlled by the frequency control signal.

4. The RF front-end receiver according to claim 3, wherein the frequency control signal is provided from a frequency synthesizer or a base band processor.

5. The RF front-end receiver according to claim 3, wherein the frequency control signal includes an analog frequency control signal and a digital frequency control signal.

6. The RF front-end receiver according to claim 3, wherein the frequency of the resonant frequency signal is controlled by an analog frequency control signal and a digital frequency control signal, and
wherein, a resonant frequency of the receive amplifier and the receive mixer is controlled by the frequency control signal or only the digital frequency control signal.

7. The RF front-end receiver according to claim 6, wherein the receive amplifier has a net input resistance controlled by the digital frequency control signal.

8. An RF front-end transmitter comprising:
an oscillator for outputting a resonant frequency signal whose frequency is controlled by a frequency control signal;
a transmit mixer for mixing a transmit base band signal and the resonant frequency signal to convert the transmit base band signal into a transmit RF signal; and
a transmit amplifier for amplifying and outputting the transmit RF signal, wherein a resonant frequency of at least one of the transmit mixer and the transmit amplifier is controlled by the frequency control signal.

9. The RF front-end transmitter according to claim 8, wherein the frequency control signal is provided from a frequency synthesizer or a base band processor.

10. The RF front-end transmitter according to claim 8, wherein the frequency control signal includes an analog frequency control signal and a digital frequency control signal.

11. The RF front-end transmitter according to claim 8,
wherein the frequency of the resonant frequency signal is controlled by an analog frequency control signal and a digital frequency control signal, and
wherein, a resonant frequency of the transmit amplifier and the transmit mixer is controlled by the frequency control signal or only the digital frequency control signal.

12. The RF front-end transmitter according to claim 11, wherein the transmit amplifier has a net input resistance controlled by the digital frequency control signal.

13. An amplifier comprising:
an amplification unit for amplifying a signal inputted to an input unit and outputting the amplified signal to an output unit; and
an input resonant unit connected to the input unit, and for changing a resonant frequency in accordance with a frequency control signal,
wherein the frequency control signal is used to control a frequency of a resonant frequency signal outputted from an oscillator.

14. The amplifier according to claim 13, further comprising:
an output resonant unit connected to the output unit, and for changing the resonant frequency in accordance with the frequency control signal.

15. The amplifier according to claim 13, wherein the frequency control signal includes an analog frequency control signal and a digital frequency control signal.

16. The amplifier according to claim 13, wherein the resonant unit is any one of a first LC tank including a inductor controlled by the digital frequency control signal and a capacitor controlled by the analog frequency control signal; a second LC tank including a capacitor controlled by the digital frequency control signal, a capacitor controlled by the analog frequency control signal and a fixed capacitor; a third LC tank including an inductor and a capacitor controlled by the digital frequency control signal, and a capacitor controlled by the analog frequency control signal and a fixed inductor; and a fourth LC tank including an inductor controlled by the digital frequency control signal, an inductor controlled by the analog frequency control signal and a fixed capacitor.

17. The amplifier according to claim 13, wherein the frequency control signal includes a digital frequency control signal.

18. The amplifier according to claim 13, further comprising:
a net resistance control unit connected to the input unit, and for changing the net input resistance in accordance with the frequency control signal.
